(19) United States
(12) Patent Application Publication
(10) Pub. No.: US 2019/0127249 A1
(43) Pub. Date: May 2, 2019

(54) SYSTEM FOR TREATING SHIPS' BALLAST WATER

(71) Applicant: KURITA WATER INDUSTRIES LTD., Tokyo (JP)

(72) Inventor: Masaaki WAKITA, Tokyo (JP)

(21) Appl. No.: 16/089,557

(22) PCT Filed: Sep. 2, 2016
(86) PCT No.: PCT/JP2016/075762

§ 371 Date: Sep. 28, 2018

(30) Foreign Application Priority Data
Mar. 31, 2016 (JP) 2016-071288

(51) Int. Cl. C02F 1/76; B63B 13/00

(52) U.S. Cl. CPC C02F 1/76; C02F 2103/008; B63B 13/00

(57) ABSTRACT

The system for treating ships' ballast water, which is attached to a ship that sails a sea route having a plurality of calling ports, comprises: a disinfectant reservoir that stores a disinfectant; a data acquisition means that acquires stored disinfectant information regarding a remaining amount and an effective chlorine concentration of a disinfectant stored in the disinfectant reservoir; a data storage means that stores supplier information regarding a disinfectant supplier at each of the plurality of calling ports and sea route information regarding a call sequence and a call schedule for the plurality of calling ports; and a data calculation means that determines whether or not an order for the disinfectant has to be placed, on the basis of the stored disinfectant information.

### TECHNICAL FIELD

The present invention relates to a system for treating ships' ballast water and particularly to a system for treating ships' ballast water that allows an order for a ballast water treatment agent to be placed at appropriate timing.

### BACKGROUND ART

Ships, in particular cargo ships, are generally designed on the assumption that they include weight of the loaded cargos and the like and, therefore, a ship in a state of empty or with few cargos takes in sea water or the like at a port before leaving the port to keep balance of the ship because of the necessity of ensuring the propeller immersion depth and navigational safety, etc., when empty. The water used as the ballast is referred to as ships' ballast water. The ships' ballast water may be sea water or the like charged into a ballast tank at a port when leaving the port with no cargo, while the ships' ballast water is discharged when loading cargos at a port.

When charging and discharging of the ships' ballast water are carried out by ships that shuttle between loading ports and unloading ports of different environments, there is a concern of adversely affecting the coastal ecosystems due to the difference of microorganisms included in the ships' ballast water between a loading port and an unloading port. In this context, the International Convention for the Control and Management of Ships' Ballast Water and Sediments was adopted in February, 2004 at the international conference for the management of ships' ballast water, and it has been made obligatory to treat the ships' ballast water.

The standards for ships' ballast water treatment established by the International Maritime Organization (IMO) are as follows: the number of living organisms of 50 μm or larger (mainly zooplanktons) included in ships' ballast water to be discharged from ships is less than 10 per 1 m³; the number of living organisms of 10 μm or larger and smaller than 50 μm (mainly phytoplanktons) is less than 10 per 1 ml; the number of Vibrio cholerae is less than 1 cfu per 100 ml; the number of Escherichia coli is less than 250 cfu per 100 ml; and the number of Intestinal Enterococci is less than 100 cfu per 100 ml.

To satisfy such standards for ships' ballast water treatment, a system for treating ships' ballast water may often be employed, which includes a combination of a storage apparatus or an onboard generation apparatus for active substances (disinfectants) such as chlorine-based ones and oxygen-based ones, an addition apparatus for adding such active substances to the ballast water, and a neutralizer addition apparatus for neutralizing the active substances remaining in the ballast water when discharging the ballast water. For example, Patent Document 1 discloses a method for treating ballast water, which includes adding a chlorine-based disinfectant such as sodium hypochlorite to the ballast water to ensure a residence time, thereby disinfecting microorganisms and the like.

In general, as disinfectants, chlorine-based disinfectants are used and, in particular, sodium hypochlorite may often be used because it is widely used for sterilization and disinfection and is available worldwide. On the other hand, sodium sulfite or sodium bisulfite is used as the neutralizer. For example, Patent Document 1 discloses a method for treating ballast water, which includes adding a chlorine-based disinfectant such as sodium hypochlorite to the ballast water to ensure a residence time, thereby disinfecting microorganisms and the like, and reducing the residual chlorine with a neutralizer such as sodium sulfite or sodium bisulfite.

It is known that sodium hypochlorite gradually deteriorates after production and the effective chlorine concentration decreases. In a normal case, the effective chlorine concentration is about 12% immediately after production, but gradually decreases after production and stabilizes at about 6%. This deterioration phenomenon is promoted if the temperature is high; therefore, on a ship, the sodium hypochlorite is stored and managed under a controlled temperature.

### PRIOR ART DOCUMENT

### Patent Document

[Patent Document 1] Japanese Patent Publication No. 2009-297610

### SUMMARY OF THE INVENTION

### Problems to be Solved by the Invention

Industrial chemicals are ordinarily stored in warehouses and the like after production and then delivered to customers. In the case of sodium hypochlorite, it is not unusual that the effective chlorine concentration has already decreased when delivered because the management of the storage temperature and storage period may not be appropriate depending on the region and manufacturer.

Meanwhile, systems for treating ships' ballast water must undergo a test using a method provided by the guideline of the International Maritime Organization (IMO), receive the final certification by the IMO on environmental impacts, and obtain the type approval by the supervisory authority in each country. In such procedures, rules are explicitly provided for the chlorine concentration (also referred to as an active substance concentration, a TRO concentration, or the like) in the ships' ballast water during the ballast water treatment process. Therefore, if the delivered sodium hypochlorite is deteriorated and the effective chlorine concentration decreases, a situation occurs in which the required amount of sodium hypochlorite may have to be increased when added to the volume of ships' ballast water to be treated, which is determined depending on the ship.

In addition, if hypochlorous acid deteriorates, it becomes toxic chloric acid, but when examined by the IMO, the concentration of chloric acid in the discharged water is restricted. Thus, depending on the degree of deterioration of sodium hypochlorite, the sodium hypochlorite cannot be used for addition to the ships' ballast water and it is necessary to treat or discard the sodium hypochlorite, which cannot be used as such, on the ship or at a calling port.

The present invention has been made in consideration of such circumstances and an object of the present invention is to provide a system for treating ships' ballast water that makes it possible to receive the delivery of a disinfectant having deteriorated as little as possible.

### Means for Solving the Problems

To achieve the above object, the present invention provides a system for treating ships' ballast water, the system being attached to a ship that sails a sea route having a plurality of calling ports, the system comprising: a disinfectant reservoir that stores a disinfectant; a data acquisition means that acquires stored disinfectant information regarding a remaining amount and an effective chlorine concentration of a disinfectant stored in the disinfectant reservoir; a data storage means that stores supplier information regarding a disinfectant supplier at each of the plurality of calling ports and sea route information regarding a call sequence and a call schedule for the plurality of calling ports; and a data calculation means that determines whether or not an order for the disinfectant has to be placed, on the basis of the stored disinfectant information, wherein when determining that the order for the disinfectant has to be placed, the data calculation means makes a determination as to which calling port among the plurality of calling ports at which the order for the disinfectant is placed with an disinfectant supplier (Invention 1).

According to the above invention (Invention 1), necessity of placing an order for the disinfectant is determined on the basis of the stored disinfectant information regarding the remaining amount and effective chlorine concentration of the disinfectant in the disinfectant reservoir. When placing an order for the disinfectant is necessary, the supplier can be determined on the basis of the supplier information and the sea route information, which are preliminarily stored in the data storage means, so that the disinfectant is delivered at appropriate timing at a calling port suitable for delivery. It is thus possible to receive the delivery of a disinfectant having deteriorated as little as possible.

In particular, the system for treating ships' ballast water of the above invention (Invention 1) is preferably used when the disinfectant is sodium hypochlorite (Invention 2).

In the above invention (Invention 1, 2), the supplier information preferably includes information regarding a lead time required for delivering a disinfectant that is not deteriorated to the ship from when a disinfectant supplier at each of the plurality of calling ports accepts the order (Invention 3).

If an order for the disinfectant is placed without considering the lead time from the order placed with a disinfectant supplier to the delivery of the disinfectant to the ship, a situation may occur in which it takes time to deliver the disinfectant after arriving at the calling port, which may lead to a situation in which the cargo handling operation cannot be carried out until the ship's ballast water is treated, thus resulting in an increased expense burden due to the extension of staying time at the port. On the contrary, if an order for the disinfectant is placed on the safe side, a situation can take place in which the disinfectant is delivered early beyond the necessity, but as a result, there is a possibility that the disinfectant deteriorates during storage on the ship, which may need extra labor and expense to treat or discard the unused disinfectant. According to the above invention (Invention 3), the disinfectant supplier can be determined on the basis of the information regarding the lead time required for delivering a disinfectant that is not deteriorated to the ship from when a disinfectant supplier at each of the plurality of calling ports accepts the order. The delivery of a disinfectant having deteriorated as little as possible can therefore be received at more appropriate timing and it is thus possible to reduce the risk that the expense burden increases due to the extension of staying time at the port and the extra labor and expense are needed to treat or discard the unused disinfectant.

In the above invention (Invention 1 to 3), the system may further comprise a data communication means that places the order for the disinfectant with the disinfectant supplier determined by the data calculation means (Invention 4). In the above invention (Invention 4), the data communication means preferably automatically places the order for the disinfectant in response to the determination of the disinfectant supplier made by the data calculation means (Invention 5).

According to the above invention (Invention 4, 5), the supplier can be determined such that the disinfectant is delivered at appropriate timing at a calling port suitable for delivery, and the determination can be promptly conveyed to the supplier. It is thus possible to more steadily receive the delivery of a disinfectant having deteriorated as little as possible.

### Effect of the Invention

According to the system for treating ships' ballast water of the present invention, it is possible to receive the delivery of a disinfectant having deteriorated as little as possible.

### BRIEF DESCRIPTION OF DRAWINGS

FIG. 1 is an explanatory diagram illustrating the configuration of a system for treating ships' ballast water according to an embodiment of the present invention.

FIG. 2 is an explanatory diagram illustrating the configuration of a data processing device in the treatment system.

FIG. 3 is an explanatory diagram illustrating the calling ports and sea route for a ship equipped with the treatment system.

### EMBODIMENTS FOR CARRYING OUT THE INVENTION

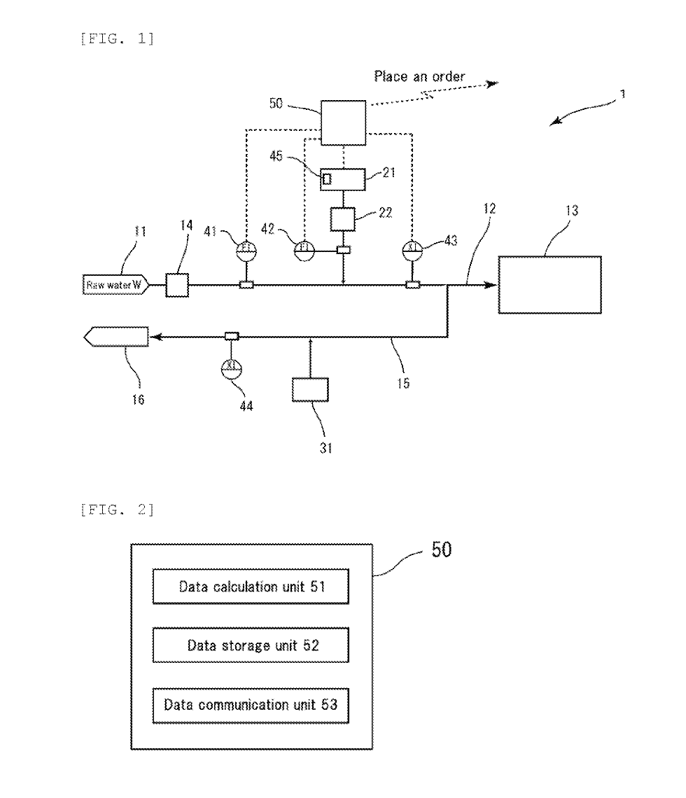

Hereinafter, one or more embodiments of the present invention will be described with reference to the drawings. As illustrated in FIG. 1, the system for treating ships' ballast water 1 according to the present embodiment may include a water intake part 11 for raw water W as ballast water, a main line 12 that is connected to the water intake part 11 and feeds the raw water W, and a ballast tank 13 provided at the end of the main line 12. A liquid feed pump 14 as a means for feeding the raw water W may be provided just downstream the position at which the water intake part 11 is connected to the main line 12. The main line 12 branches to a discharge line 15 at the midstream of the main line 12 (before the ballast tank 13), and the end of the discharge line 15 serves as a drainage part 16. The branch point from the main line 12 to the discharge line 15 may be provided with an on-off valve (not illustrated) that switches between the main line 12 and the discharge line 15.

The midstream of the main line 12 may be provided with a disinfectant supply line that includes a disinfectant reservoir 21 and a liquid feed pump 22. The disinfectant supply line is configured to be able to inject the disinfectant into the raw water W flowing in the main line 12. The midstream of the discharge line 15 may be provided with a neutralizer solution supply line that includes a neutralizer solution reservoir 31. The neutralizer solution supply line is configured to be able to inject the neutralizer solution into the discharged water (discharged ballast water) from the ballast tank 13 flowing in the discharge line 15.

On the main line 12, a first flow meter 41 may be provided on the downstream side of the liquid feed pump 14 and on the upstream side of the connection part with the disinfectant supply line. The first flow meter 41 measures the flow rate of the raw water W flowing through the main line 12. On the disinfectant supply line, a second flow meter 42 may be provided on the downstream side of the liquid feed pump 22. The second flow meter 42 measures the flow rate of the disinfectant injected into the main line 12. On the main line 12, a first chlorine concentration meter 43 may be provided on the downstream side of the connection part with the disinfectant supply line. The first chlorine concentration meter 43 measures the concentration of chlorine in the ballast water (which is obtained by injecting the disinfectant into the raw water W). On the discharge line 15, a second chlorine concentration meter 44 may be provided on the downstream side of the connection part with the neutralizer solution supply line. The second chlorine concentration meter 44 measures the concentration of chlorine in the discharged ballast water.

In the present embodiment, sodium hypochlorite may be used as the disinfectant while sodium sulfite or sodium bisulfite may be used as the neutralizer. The treatment system 1 of the present embodiment may not necessarily be used only with these disinfectant and neutralizer, but may preferably be used particularly when the disinfectant is sodium hypochlorite.

The disinfectant reservoir 21 may have a temperature management function achieved by a water-cooling chiller, an air-cooling chiller, or the like and store and manage the disinfectant in a state in which the temperature is controlled, thereby to suppress the phenomenon that the disinfectant deteriorates due to high temperatures on the ship.

As will be understood, the disinfectant reservoir 21 may have a size that allows for storage of the disinfectant with which the ballast water can be treated once, but may preferably have a capacity enough to treat the ballast water at least twice and more preferably three times. When the disinfectant reservoir 21 has such a capacity, the necessary amount of effective chlorine can be injected into the volume of the ship's ballast water even if the disinfectant deteriorates during storage. A level meter 45 may be installed in the disinfectant reservoir 21 and can measure the remaining amount of the disinfectant in the disinfectant reservoir 21.

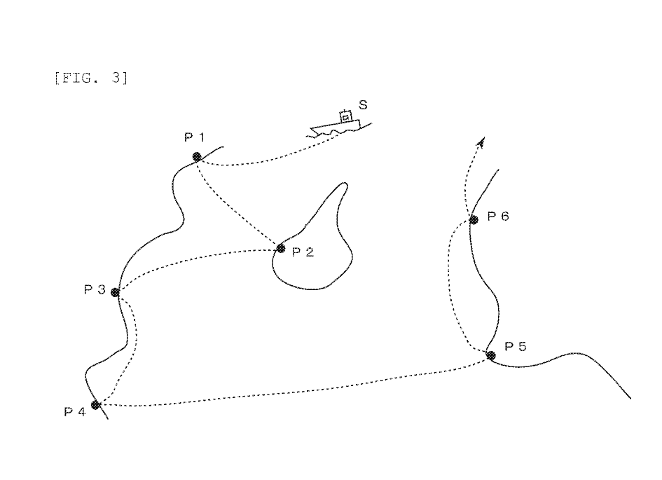

A data processing device 50 may be provided in the ship S equipped with the treatment system 1 according to the present embodiment. The data processing device 50 may be, for example, a general-purpose personal computer or the like installed in the bridge, wheelhouse, engine room, or the like of the ship S. As illustrated in FIG. 2, the data processing device 50 may include a data calculation unit 51, a data storage unit 52, and a data communication unit 53. The data processing device 50 is connected to four meters so as to be capable of electrical communication with each other. The four meters comprise: the first flow meter 41 which measures the flow rate of the raw water W flowing through the main line 12; the second flow meter 42 which measures the flow rate of the disinfectant added into the main line 12; the first chlorine concentration meter 43 which measures the concentration of chlorine in the ballast water; and the level meter 45 which measures the remaining amount of the disinfectant in the disinfectant reservoir 21. The data processing device 50 is configured to be able to receive the measured value data acquired by each meter from the meter.

The data calculation unit 51 serves to acquire stored disinfectant information regarding the remaining amount and effective chlorine concentration of the disinfectant stored in the disinfectant reservoir 21 and determines whether or not an order for the disinfectant has to be placed, on the basis of the stored disinfectant information. When determining that the order for the disinfectant has to be placed, the data calculation unit 51 makes a determination as to which calling port among a plurality of calling ports at which the order for the disinfectant is placed with a disinfectant supplier, on the basis of supplier information and sea route information, which will be described later.

The stored disinfectant information may include information regarding the remaining amount of the disinfectant in the disinfectant reservoir 21, which is received from the level meter 45, and information regarding the effective chlorine concentration of the disinfectant in the disinfectant reservoir 21, which is estimated from the concentration of chlorine in the ballast water received from the first chlorine concentration meter 43.

In the present embodiment, the effective chlorine concentration of the disinfectant in the disinfectant reservoir 21 may be estimated as follows. The ballast water treatment may be carried out so that the concentration of chlorine in the ballast water measured by the first chlorine concentration meter 43 becomes a prescribed chlorine concentration T (mg/L as Cl₂). In this operation, the relationship of T=1000c*s/b is established using a ballast water flow rate b (m³/h) measure by the first flow meter 41, a disinfectant flow rate s (m³/h) measured by the second flow meter 42, and an effective chlorine concentration c (g/L) of the disinfectant in the disinfectant reservoir 21. However, considering that the concentration of chlorine in the ballast water decreases by about 20% due to the early decrease until the concentration of chlorine is measured by the first chlorine concentration meter 43 from when the disinfectant is injected, the above relationship may be modified to 1.2*T=1000c*s/b, and the effective chlorine concentration of the disinfectant in the disinfectant reservoir 21 can be obtained using an equation of c=1.2 Tb/1000 s.

The data storage unit 52 may preliminarily store the supplier information and the sea route information. The supplier information, which is information regarding a disinfectant supplier at each of a plurality of calling ports for the ship S, may include information regarding a lead time required for delivering a disinfectant that is not deteriorated to the ship from when a disinfectant supplier at each of the plurality of calling ports for the ship S accepts the order. The sea route information is information regarding a call sequence and a call schedule for the plurality of calling ports for the ship S.

Specifically, as illustrated in FIG. 3 for example, when cargos are loaded and unloaded for the ship S at a plurality of calling ports P1, P2, P3, P4, P5, and P6, the data storage unit 52 may store the sea route information, such as information on the schedule that the ship S sails in the order of P1-P2-P3-P4-P5-P6, the scheduled date of arrival at each calling port, the number of days required for loading and unloading the cargos, and the scheduled date of departure from each calling port. The data storage unit 52 may also store the supplier information, such as information on a disinfectant supplier at each calling port and the lead time required for delivering a disinfectant that is not deteriorated to the ship from when each disinfectant supplier accepts the order.

When the data calculation unit 51 determines that an order for the disinfectant has to be placed and makes a determination as to which calling port among the plurality of calling ports P1, P2, P3, P4, P5, and P6 at which the order for the disinfectant is placed with a disinfectant supplier, the data communication unit 53 may transmit the ordering data to order the disinfectant to the supplier with which the order is determined to be placed. The transmission of the ordering data may be carried out, for example, by sending an e-mail, sending data in an on-line system dedicated to placing the order online, sending a facsimile, or the like or by using other communication means. In addition or alternatively, the system may be configured such that the order for the disinfectant is automatically placed in response to the determination of the supplier made by the data calculation unit 51, and it is thereby possible to promptly convey the determination of the order to the supplier and more steadily receive the delivery of a disinfectant having deteriorated as little as possible.

A processing flow leading up to receiving the delivery of a disinfectant having deteriorated as little as possible will be described. This flow may be executed by the treatment system 1 having the configuration as described above. First, after the ballast water treatment is carried out at a calling port, the level meter 45 measures a remaining amount V (m³) of the disinfectant in the disinfectant reservoir 21, and the data calculation unit 51 acquires the measured value. The first chlorine concentration meter 43 measures a chlorine concentration T (mg/L as Cl₂) of the ballast water, which may be used together with the ballast water flow rate b (m³/h) measured by the first flow meter 41 and the disinfectant flow rate s (m³/h) measured by the second flow meter 42, thereby to estimate the effective chlorine concentration c (g/L) of the disinfectant in the disinfectant reservoir 21, and the data calculation unit 51 acquires the estimated value.

For the ballast water treatment at the next calling port, the amount of disinfectant V₀ (m³) necessary for the ballast water B (m³) as an object of the treatment to have a prescribed concentration T (mg/L as Cl₂) may be obtained in accordance with V₀=1.2BT/1000c on the basis of the relational expression 1.2T=1000c*V₀/B which is modified from the relational expression T=1000c*V₀/B obtained with consideration for the decrease of 20% due to the early decrease of the concentration of chlorine in the ballast water.

The data calculation unit 51 may compare the remaining amount V (m³) of the disinfectant in the disinfectant reservoir 21 with the necessary amount of disinfectant V₀ (m³) and determine that an order for the disinfectant has to be placed, for example, upon V<2V₀.

When determining that the order for the disinfectant has to be placed, the data calculation unit 51 may make a determination as to which calling port at which the order for the disinfectant is placed with a disinfectant supplier, on the basis of the sea route information and supplier information stored in the data storage unit 52. For example, provided that the required time from the current location to the first calling port P1 is T1, the lead time required at P1 is L1, the required time from the calling port P1 to the second calling port P2 is T2, and the lead time required at P2 is L2, when T1≥L1 is satisfied, delivery at the first calling port P1 can be ordered thereby to allow the delivery of the disinfectant, which is not deteriorated, to be received.

In the case of T1<L1 and T1+T2≥L2, when V₀<V<2V₀ is satisfied, delivery at the first calling port P1 may not be ordered and delivery at the second calling port P2 may be ordered. After the cargos are unloaded at the first calling port P1, V<V₀ holds, but no particular problem occurs because the delivery of a disinfectant that is not deteriorated can be received at the second calling port P2.

Likewise, in the case of T1<L1 and T1+T2≥L2, if V<V₀ holds, this causes a shortage of the disinfectant used when treating the ballast water at the first calling point P1. In such a case, therefore, delivery of the disinfectant for compensating for the shortage in the ballast water treatment at the first calling port P1 may be ordered, and delivery at the second calling port P2 may also be ordered. In this case, the lead time required for delivering a disinfectant that is not deteriorated may be insufficient because of T1<L1 at the calling port P1, so that a disinfectant that is deteriorated to some extent will be delivered, but at the second calling port P2, delivery of a disinfectant that is not deteriorated can be received. Placing the order in this way makes it possible to minimize the amount of the delivered disinfectant which is deteriorated to some extent. As will be understood, in such a case, it may be difficult to avoid the delivery of a disinfectant that is deteriorated to some extent at the calling port P1, and it is thus preferred to execute the control so that such situations take place as little as possible.

When the data calculation unit 51 determines that an order for the disinfectant has to be placed and makes a determination as to which calling port among the plurality of calling ports P1, P2, P3, P4, P5, and P6 at which the order for the disinfectant is placed with a disinfectant supplier, the data communication unit 53 may automatically transmit the ordering data to order the disinfectant to the supplier with which the order is determined to be placed. Through this operation, the supplier can be determined such that the disinfectant is delivered at appropriate timing at a calling port suitable for delivery, and the determination can be promptly conveyed to the supplier. It is thus possible to more steadily receive the delivery of a disinfectant having deteriorated as little as possible. In usual cases, the amount of order may be the difference between the remaining amount V of the disinfectant in the disinfectant reservoir 21 and the tank capacity of the disinfectant reservoir 21.

According to such a treatment system 1, necessity of placing an order for the disinfectant is determined on the basis of the stored disinfectant information regarding the remaining amount and effective chlorine concentration of the disinfectant in the disinfectant reservoir 21. When placing an order for the disinfectant is necessary, the supplier can be determined on the basis of the supplier information and the sea route information, which are preliminarily stored in the data communication unit 53, so that the disinfectant is delivered at appropriate timing at a calling port suitable for delivery. It is thus possible to receive the delivery of a disinfectant having deteriorated as little as possible.

In particular, information on the lead time required for delivering a disinfectant that is not deteriorated to the ship S from when a disinfectant supplier at each of the plurality of calling ports for the ship S accepts the order may be included as one item of the supplier information which is preliminarily stored in the data communication unit 53, and the delivery of a disinfectant having deteriorated as little as possible can thereby be received at more appropriate timing. It is thus possible to reduce the risk that the expense burden increases due to the extension of staying time at the port and the extra labor and expense are needed to treat or discard the unused disinfectant.

The embodiments heretofore explained are described to facilitate understanding of the present invention and are not described to limit the present invention. It is therefore intended that the elements disclosed in the above embodiments include all design changes and equivalents to fall within the technical scope of the present invention.

For example, in the present embodiment, the effective chlorine concentration of the disinfectant in the disinfectant reservoir 21 is estimated from the concentration of chlorine in the ballast water received from the first chlorine concentration meter 43, but the effective chlorine concentration of the disinfectant in the disinfectant reservoir 21 may also be directly measured.

In the present embodiment, one data processing device 50 is configured to achieve each of functions of the data acquisition means, the data calculation means, the data storage means, and the data communication means, but the system may also be configured such that multiple devices are used to separately achieve each of functions of the data acquisition means, the data calculation means, the data storage means, and the data communication means.

In addition or alternatively, the system may be configured such that, when the data calculation unit 51 of the data processing device 50 cannot determine or select a disinfectant supplier due to the time limit for placing an order or the like, a warning against this fact is given to the crew members through an audio output device (not illustrated) and/or a display device (not illustrated) such as a liquid-crystal monitor, so that a crew member who receives the warning can manually place an order for the disinfectant with an optimum supplier.

### DESCRIPTION OF REFERENCE NUMERALS

1 System for treating ships' ballast water
11 Water intake part
12 Main line
13 Ballast tank
14 Liquid feed pump
15 Discharge line
16 Drainage part
21 Disinfectant reservoir
22 Liquid feed pump
31 Neutralizer solution reservoir
41 First flow meter
42 Second flow meter
43 First chlorine concentration meter
44 Second chlorine concentration meter
50 Level meter
50 Data processing device
51 Data calculation unit
52 Data storage unit
53 Data communication unit

1. A system for treating ships' ballast water, the system being attached to a ship that sails a sea route having a plurality of calling ports, the system comprising:
a disinfectant reservoir that stores a disinfectant;
a data acquisition means that acquires stored disinfectant information regarding a remaining amount and an effective chlorine concentration of a disinfectant stored in the disinfectant reservoir;
a data storage means that stores supplier information regarding a disinfectant supplier at each of the plurality of calling ports and sea route information regarding a call sequence and a call schedule for the plurality of calling ports; and
a data calculation means that determines whether or not an order for the disinfectant has to be placed, on a basis of the stored disinfectant information,
wherein when determining that the order for the disinfectant has to be placed, the data calculation means makes a determination as to which calling port among the plurality of calling ports at which the order for the disinfectant is placed with a disinfectant supplier.

2. The system for treating ships' ballast water according to claim 1, wherein the disinfectant is sodium hypochlorite.

3. The system for treating ships' ballast water according to claim 1, wherein the supplier information includes information regarding a lead time required for delivering a disinfectant that is not deteriorated to the ship from when a disinfectant supplier at each of the plurality of calling ports accepts the order.

4. The system for treating ships' ballast water according to claim 1, further comprising
a data communication means that places the order for the disinfectant with the disinfectant supplier determined by the data calculation means.

5. The system for treating ships' ballast water according to claim 4, wherein the data communication means automatically places the order for the disinfectant in response to the determination of the disinfectant supplier made by the data calculation means.
